(19) United States
(12) Patent Application Publication
(10) Pub. No.: US 2006/0005467 A1
(43) Pub. Date: Jan. 12, 2006

(54) Self contained gardening unit

(76) Inventor: Phyllis R. Washburn, Forest City, NC (US)

Correspondence Address: HIGH TECHNOLOGY PATENTS, INC., 3825 GREEN VALLEY DRIVE, PITTSBURGH, PA, 15235, US

(21) Appl. No.: 11/159,971

(22) Filed: Jun. 23, 2005

Related U.S. Application Data
(60) Provisional application No. 60/582,309, filed on Jun. 24, 2004.

(51) Int. Cl. A01G 9/02

(52) U.S. Cl. 47/65.5

(57) ABSTRACT

A planter includes a pan for potting soil, the pan having drain holes. A drip pan is disposed beneath the pan for potting soil, the drip pan being attachable to a drain hose, and the base has space for hiding the drain hose. Preferably, the planter includes a mobile base including wheels and the planter includes at least one handle for moving the planter.

### CROSS-REFERENCE TO RELATED APPLICATIONS

The present invention claims priority from the provisional patent application No. 60/582,309 filed on Jun. 24, 2004, entitled “Self Contained Gardening Units”. The present invention is also closely related to the copending patent application entitled “Interlocking Panels” which is being filed concurrently with the present application. Furthermore, the teachings of the provisional patent application and the copending application are herein incorporated by reference thereto.

### FIELD OF THE INVENTION

The present invention relates, in general, to gardening aids and, more particularly, the instant invention relates to a planter for flowers or vegetables.

### BACKGROUND OF THE INVENTION

Most urban consumers are not interested in growing very large gardens, but would like to grow a few of their favorite vegetables or flowers. Many such consumers have no gardening experience and have very little gardening equipment. Some urban consumers, furthermore, have no yard whatever and must restrict their gardening activities to pots and planters.

Furthermore, many people believe that modern farming does not always provide food having essential vitamins. Much soil used for faring is overworked, and the food is often harvested some time before it reaches the consumer's table. Vitamin pills are available, but a consumer may question whether all necessary vitamins are included, and whether vitamin pills may supply a harmfull excess of the well-known vitamins.

Glycoscience is a new field which is finding that there are essential sugars which may be lacking in food which is not grown locally, harvested at the peak of ripeness, and eaten soon after harvesting. It therefore appears advisable for the consumer to supplement his diet with some home grown vegetables.

Flavor is another issue. Commercially grown tomatoes, for example, may be a type which is selected for its durability, so the tomatoes can be picked green, shipped thousands of miles, ripen in transit, and look attractive in the grocery store. Such tomatoes are well known to lack flavor, and may lack nutrients.

Flowers are extremely difficult to raise and market, and as a result, prices tend to be very high. For this reason, alone, a person may wish to grow his or her own. Furthermore, a person who enjoys flowers may wish to observe the entire life cycle of the flowers as they put forth green shoots, then leaves, then buds, and then watch the buds open up into flowers.

The patent literature includes a number of interesting references for various types of planters. U.S. Pat. No. 6,729,070 teaches a novel combination of a conventional plant pot with one or more drain holes and a perforated conduit or tube which is placed inside the pot. The perforated conduit or tube acts as an aerating root pruner and provides air and water communication between the top and bottom of the pot.

U.S. Pat. No. 6,840,008 describes a vertical planting system comprising individual growing containers. The unit includes a nutrient and water diffuser box.

U.S. Pat. No. 6,862,843 is an umbrella planter that is for a patio table with an umbrella. The planter has an annular design which is for surrounding the pole of the umbrella.

U.S. Pat. No. 6,874,293 is a concrete block for incorporation into a vertical retaining wall. The block includes an upwardly directed opening which is exposed for receiving soil and plants when the block is incorporated into a wall.

U.S. Pat. No. 6,877,276 is a planter with a drainage spout that extends downwardly and outwardly to a drain opening horizontally displaced from the planter. It can be used on or above a porch railing and directs water away from the porch.

U.S. Pat. No. 6,901,700 teaches a planter comprising an outer pot enclosing a plurality of inner pots and filler soil sround the inner pots.

U.S. Pat. No. 6,715,233 is a self watering modular planter insert reservoir for water. Dispensation of water is controlled by a hydrophilic sensor.

U.S. Pat. No. 5,503,931 teaches a water retaining material which is made by burning rice hulls. The material can be included in soil to enhance the moisture retaining aspect of the soil, and would be ideal for planters.

It is concluded that there is a need for apparatus and methods for facilitating the planting of vegetables and flowers by persons who have few gardening skills, few tools, and little or no land.

### INTRODUCTION TO THE INVENTION

The invention is a planter having a horticultural pan in which potting soil or other growth medium may be placed, the horticultural pan having one or more drainage holes. A drip pan lies beneath the horticultural pan, and a tube is available for draining the drip pan. Preferably, the tube may be hidden in a space beneath the drip pan. Preferably, the planter includes wheels, preferably casters, and, preferably, includes one or more handles so that it can be readily positioned. It can, for example, be moved to follow the sun, and, preferably, may be moved by a person in a wheel chair.

It is an objective of the present invention to provide a planter which can be used indoors or outdoors on a porch or patio.

It is a further objective of the present invention to provide a planter wherein soil and water may be well controlled so the planter is useable in a convalescent home or other institution.

It is another objective of the present invention to provide a planter which can be used indoors to give summer plants, such as tomato plants, a headstart by starting a number of plants early, before the end of the frost season, so they can be planted outdoors after the danger of frost is over.

It is an additional objective of the present invention to provide a planter which facilitates the placement of stakes for support of plants such as tomatoes.

A further objective of the present invention is to provide an embodiment of the planter including a mini-greenhouse to protect plants from frost.

It is an additional objective of the present invention to provide an embodiment of the planter having an optional heater to protect plants from frost.

Another objective of the present invention is to provide a planter with an optional screen to protect plants from animals such as deer and woodchucks.

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### SUMMARY OF THE INVENTION

In one aspect, the invention is a planter including a horticultural pan that is for containing potting soil or other growth media for plants, the horticultural pan having at least one drain hole. A drip pan is disposed beneath the horticultural pan, the drip pan positioned to receive water from the drain hole(s) in the horticultural pan. The drip pan is connectable to a drain hose for draining the drip pan; and the planter includes a base with space for hiding the drain hose.

In another aspect, the present invention is a planter including a horticultural pan which is for containing potting soil or other growth media for plants, a mobile base, the mobile base comprising a plurality of wheels, and at least one handle for moving the planter.

### BRIEF DESCRIPTION OF THE DRAWINGS

FIG. 1 is a perspective sketch of a planter according to the present invention;

FIG. 2 is a side view of the planter shown in FIG. 1;

FIG. 3 is an end view of the planter shown in FIG. 1;

FIG. 4 is a top view of the planter shown in FIG. 1;

FIG. 5 is a side view of the planter with a framework and a screen to protect the plants from deer, woodchucks, and other animals;

FIG. 6 is an end view of the planter shown in FIG. 5;

FIG. 7 is a top view of the planter shown in FIG. 5;

FIG. 8 is a side view of a base for the planter;

FIG. 9 is an end view of the base;

FIG. 10 is a top view of the base;

FIG. 11 is a side view of a handle for moving the planter;

FIG. 12 is an end view of the handle shown in FIG. 11;

FIG. 13 is a top view of the handle shown in FIG. 11;

FIG. 14 is a side view of a drip pan for the planter;

FIG. 15 is an end view of the drip pan shown in FIG. 14;

FIG. 16 is a top view of the drip pan shown in FIG. 14;

FIG. 17 is a side view of a horticultural pan for the planter;

FIG. 18 is an end view of the horticultural pan illustrated in FIG. 17;

FIG. 19 is a top view of the horticultural pan illustrated in FIG. 17;

FIG. 20 is a top view of an alternative horticultural pan having handles for moving the planter;

FIG. 21 is a top view of an optional mobile base for the planter;

FIG. 22 is a side view of the mobile base; and

FIG. 23 is an end view of an alternative horticultural pan with an electric heater.

### IDENTIFYING NUMERALS EMPLOYED IN THE DRAWINGS

30 Planter
32 Base of planter
33 Door in side of base
34 Handle
35 Horticultural pan which contains potting soil
36 Hoops to support plastic for greenhouse effect
37 Drain holes in pan
38 Opening in handle
40 Frame for screen
41 Screen
42 Ridge or elongate indentation to stiffen base
44 Depression or hole to engage protuberances on handle
46 Bottom rim of base
48 Opening in base
50 Hole to accommodate nipple for drain tube
52 Protuberance to mate with depression or hole 44 on base
54 Protuberance to mate with depression on underside of drip pan 60
56 Elongate depressions for stiffness
60 Drip pan
62 Depression on underside of drip pan to engage handle
64 Elongate ridge for stiffness
66 Nipple for attachment of drain tube
68 Grooves for hoops
70 Grooves for stakes
80 Preferred pan with handles
85 Handles on pan
86 Elastomer grip on handle
90 Mobile base
92 Casters
94 Substantially vertical pivot of caster
100 Alternative pan having electric heater
102 Heater tape
104 Electric plug
106 Electric receptacle
108 Electric cord

### Brief Description of the Presently Preferred and Various Alternative Embodiments of the Invention

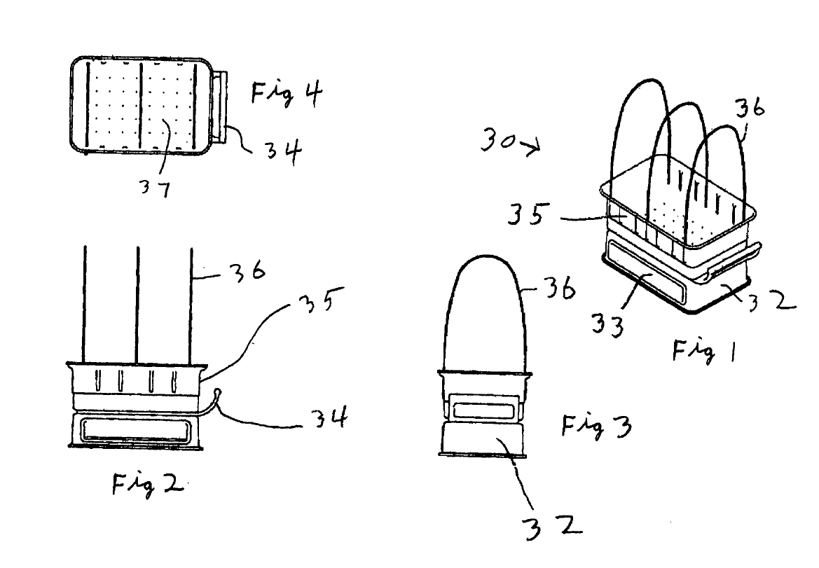

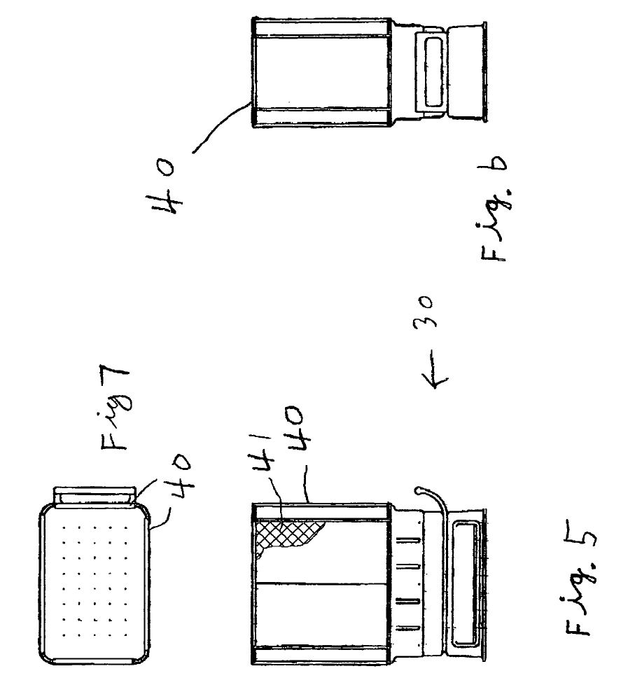

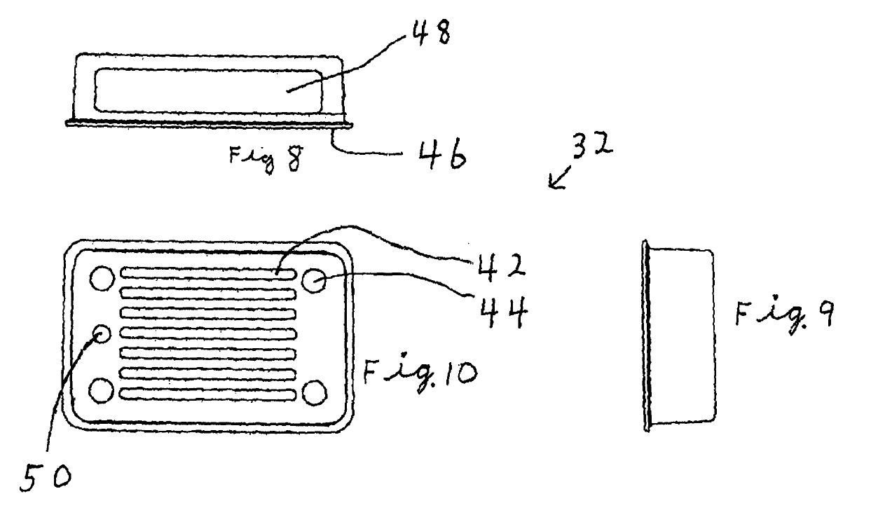

FIG. 1 is a perspective sketch of a planter 30 according to the present invention. FIG. 2 is a side view, FIG. 3 is an end view and FIG. 4 is a top view of planter 30. Planter 30 includes a base 32 and a horticultural pan 35 which is for potting soil or other growth medium. Preferably, planter 30 also includes a handle 34, and it may have wheels (discussed subsequently) so it can be conveniently positioned on a porch or patio. Planter 30 can be employed indoors or outdoors.

Preferably, base 32 has a door 33 providing access to space in base 32 for storage of gardening tools. Horticultural pan 35 has at least one drain hole 37. Planter 30 optionally includes hoops 36. These are to be employed early in the growing season when nights may be frosty. A transparent sheet (not shown) may be placed over the hoops to make a miniature greenhouse.

FIGS. 5, 6 and 7 show the planter 30 with a frame 40 which, preferably, is comprised of angle iron. Frame 40 is for support of screen 41 comprised of wire or expanded metal sheets which are to protect plants from large animals such as deer and woodchucks.

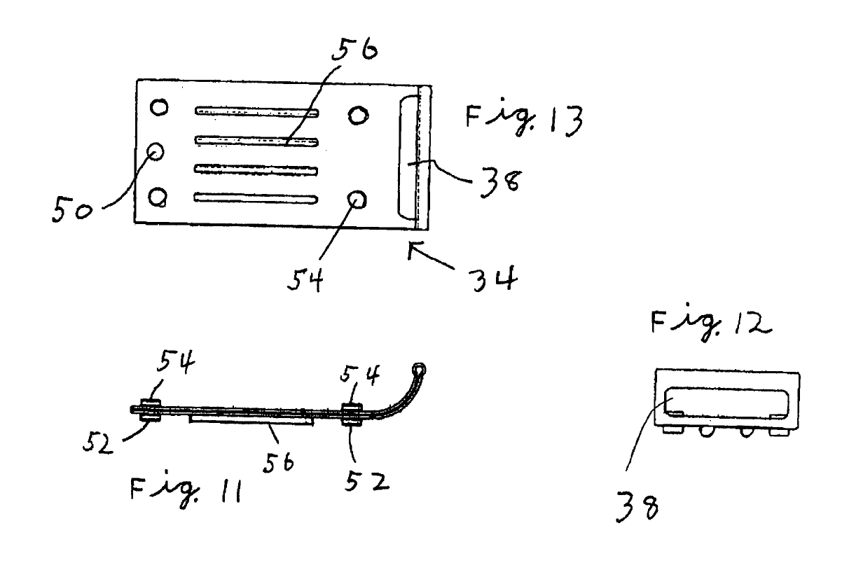

FIGS. 8, 9 and 10 show a side view, end view and top view of the base 32. The side view, FIG. 8, shows an opening 48 where door 33 is mounted. The base 32 has the form of an inverted pan with opening 48 in its side. It rests on rim 46 and is stiffened by ridges or elongate indentations 42. Holes or depressions 44 are for engagement with protuberances on the handle (discussed next). The base 32 has a hole 50 which is for a drain tube (discussed later).

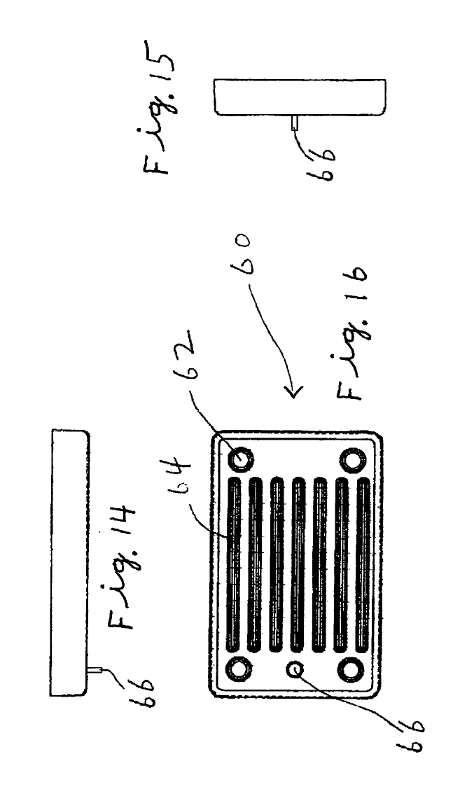

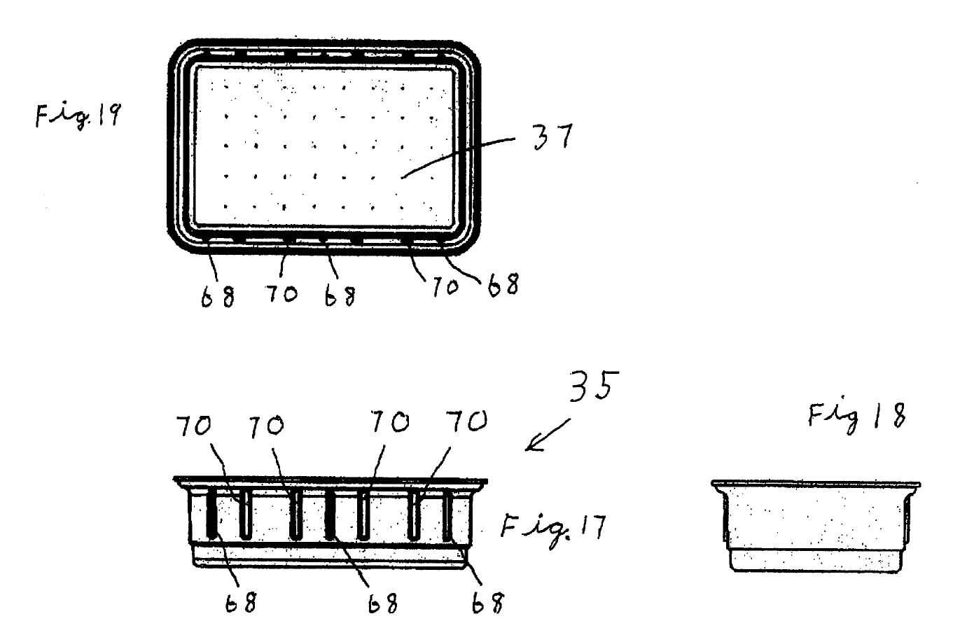

FIGS. 11, 12 and 13 illustrate side, top and end views of the handle 34. Handle 34 has an opening 38 which a person may grasp. Handle 34 has protuberances 52 on its underside which are for engaging the holes or depressions 44 on the base. Like the base, the handle 34 also has a hole 50 which is for a drain tube.

FIGS. 14, 15 and 16 show side, end and top views, respectively, of a drip pan 60 which rests on the handle 34. Protuberances 54 on the upper side of handle 34 are for engagement with depressions 62 on the underside of drip pan 60. Preferably, drip pan 60 has elongate ridges 64 which serve to stiffen the drip pan 60.

A nipple 66 on drip pan 60 is for attachment of a drain tube for drip pan 60. Preferably, nipple 66 passes through the hole 50 in the handle and the hole 50 in the base, and can be accessed from storage space in the base 32. The drain tube is hidden in the storage space behind door 33 in base 32. The user may place a clamp on the tube, and occasionally open door 33, pull the end of the tube out and remove the clamp to drain the drip pan 60 through the tube.

FIGS. 17, 18 and 19 show side, end and top views, respectively, of the horticultural pan 35 which contains potting soil or other growth media (not shown). A number of holes 37 are shown in the bottom of pan 35. At least one such hole is necessary for draining the pan 35, to prevent roots from rotting. Preferably, vertical grooves 68 are on the inside wall of pan 35, and these are for stabilizing the hoops 36 which are shown in FIGS. 1-4. The hoops 36 are held in the grooves 68 by their own spring force.

Likewise, there are grooves 70 on the inside wall of pan 35. These are for accommodating stakes such as tomato stakes. Such stakes are for the support of plants. Stakes (not shown) are held in the grooves by the pressure of soil in horticultural pan 35.

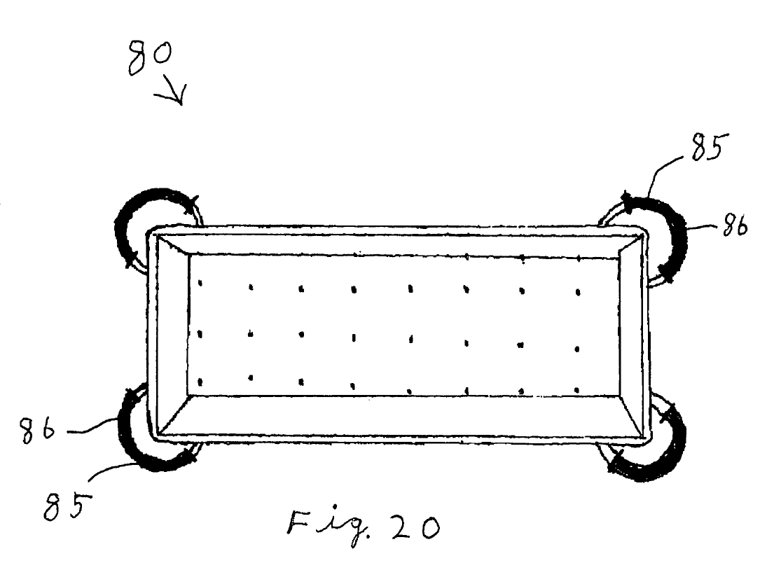

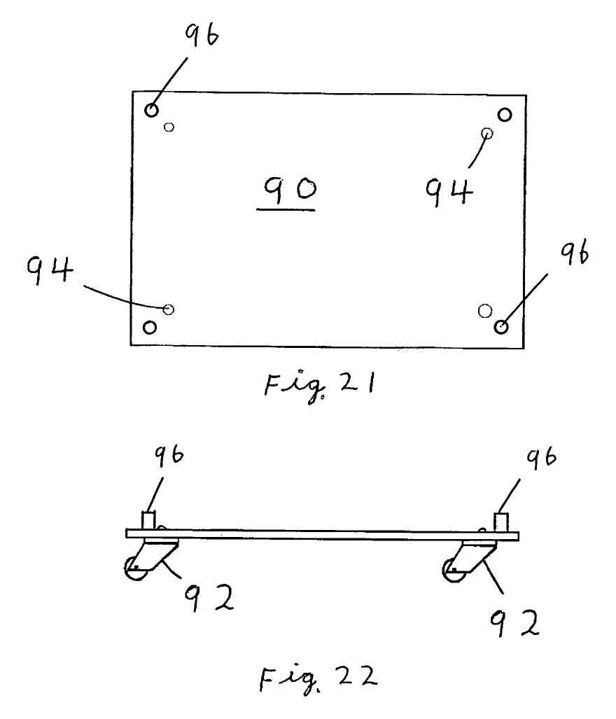

FIG. 20 is a top view of an alternative horticultural pan 80 having handles 85 which are for moving the planter. Preferably, handles 85 include elastomer grips 86. Handles 85 are intended to be useable by a person in a wheel chair.

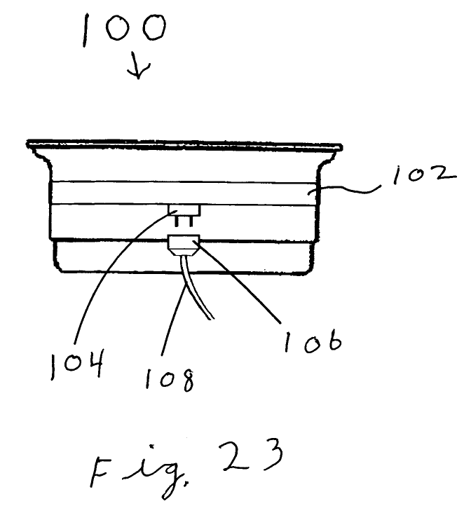

FIGS. 21 and 22 illustrates top and side views, respectively, of a mobile base 90 having wheels, preferably casters 92. Casters 92 have substantially vertical pivots 94. The casters 92 are to make the planter easy to move. When used indoors, for example, the planter can be moved to follow the sun. A planter as described above, including base 32 can be placed on mobile base 90. When base 32 is placed on mobile base 90, the rim 46 of base 32 is placed so as to enclose posts 96 on mobile base 90 to prevent base 32 from sliding on mobile base 90.

FIG. 23 illustrates an alternative horticultural pan 100 including a heater for protecting plants from frost. A heating tape 102, preferably is wrapped around horticultural pan 100, in good thermal contact with horticultural pan 100. Power is supplied through plug 104 which is for engaging receptacle 106 on power cord 108. For safety, a low voltage, preferably 12 volts is recommended for heating tape 102. Following conventional electrical practice, power cord 108 would include a ten to one step down transformer (not shown) for converting household power at 120 volts to 12 volts for the heater.

It is notable that the planter 30 is assembled in layers, and is kept as a stable unit by the weight of soil in the horticultural pan pan 35. The base 32 is placed on the mobile base 90. Then the handle is placed on the base and positioned so that protuberances 52 on the handle 34 engage holes or depressions 44 on the base 32. The drip pan 60 is then placed on the handle 34 and positioned so that protuberances 54 on handle 34 engage depressions 62.

The horticultural pan 35 is then placed so its lower portion fits into drip pan 60. When planting soil is placed in horticultural pan 35, the entire structure becomes a stable unit because of the weight of the soil.

If the prefered horticultural pan 80 is employed, the handle 34 is not required. In that case, for secure engagement of the drip pan 60 to the base 32, the base 32 would have upward protuberances rather than depressions or holes 44. These would mate with holes or depressions 62 on the underside of drip pan 60.

A planter according to the present invention may be supplied to consumers along with a preferred potting soil or other growth medium. The potting soil or medium may include a water retaining medium such as described in U.S. Pat. No. 5,503,931.

It is noted that, in lieu of the frame 40 and screen 41 shown in FIGS. 5-7, a cage comprised of interlocking panels as presented in the concurently filed patent application entitled “Interlocking Panels” may be employed to protect the plants from large animals such as deer and woodchucks.

Although the invention, with various preferred and alternative embodiments has been described in detail above, it should be understood that the invention may be otherwise embodied within the scope of the appended claims.

I claim:

1. A planter comprising:
a horticultural pan that is for containing potting soil or other growth media for plants, said horticultural pan having at least one drain hole;
a drip pan disposed beneath said horticultural pan, said drip pan positioned to receive water from said at least one drain hole in said horticultural pan;
said drip pan connectable to a drain hose for removing water from said drip pan; and
a base including space for hiding said drain hose.

2. A planter according to claim 1 wherein said drip pan includes a nipple on a lower surface thereof whereby said drain hose may be attached to said nipple.

3. A planter according to claim 1 further comprising at least one handle for moving said planter.

4. A planter according to claim 1 further comprising a plurality of wheels to facilitate movement of said planter.

5. A planter according to claim 4 wherein at least two of said wheels are casters.

6. A planter according to claim 4 wherein said plurality of wheels comprises four casters.

7. A planter according to claim 3 wherein said at least one handle is disposed on said horticultural pan.

8. A planter according to claim 7 wherein said at least one handle is disposed on at least one corner of said horticultural pan.

9. A planter according to claim 8 wherein said at least one handle is four handles, and said at least one corner of said pan is four corners of said pan.

10. A planter according to claim 8 wherein said at least one handle is formed as a ring intersecting said at least one corner of said horticultural pan.

11. A planter according to claim 10 wherein said ring is substantially horizontal.

12. A planter according to claim 3 further comprising an elastomer grip disposed on said handle.

13. A planter according to claim 3 wherein said at least one handle includes a portion disposed between said drip pan and said base.

14. A planter according to claim 3 wherein said at least one handle includes an opening for a person to grasp.

15. A planter according to claim 1 further comprising a screen and a frame supporting said screen, said screen and frame for preventing large animals from disturbing plants growing in said planter.

16. A planter according to claim 1 further comprising means for mounting stakes for support of plants.

17. A planter according to claim 1 further comprising hoops for supporting a plastic sheet to form a mini greenhouse.

18. A planter according to claim 1 comprising an electric heater for protecting plants from frost.

19. A planter comprising:
a horticultural pan which is for containing potting soil or other growth media for plants;
a mobile base, said mobile base comprising a plurality of wheels;
at least one handle for moving said planter.

20. A planter according to claim 19 wherein said plurality of wheels comprises at least two casters.
